(19) United States
(12) Patent Application Publication
(10) Pub. No.: US 2015/0112809 A1
(43) Pub. Date: Apr. 23, 2015

(54) Confirmation of a Device at a Geographic Location

(71) Applicant: igniter Inc, Bluffdale, UT (US)

(72) Inventors: W. Eric Smith, Pleasant Grove, UT (US); Mark Adams, Lehi, UT (US)

(21) Appl. No.: 14/517,620

(22) Filed: Oct. 17, 2014

Related U.S. Application Data
(60) Provisional application No. 61/892,272, filed on Oct. 17, 2013.

(51) Int. Cl. G06Q 30/02; H04W 64/00; H04W 4/02; H04L 29/08; G06F 17/30

(52) U.S. Cl. CPC G06Q 30/0261; H04L 67/22; G06F 17/30241; H04W 4/02; H04W 64/00
USPC 705/14.58; 455/456.1

(57) ABSTRACT

Technology is described for confirming that a device is at a geographic location. An identifier is associating with a geographic location. An audio signal is received containing the identifier at a mobile computing device in the geographic location. The identifier is validated via the mobile computing device to verify that the mobile computing device is at the geographic location.

### BACKGROUND

Many types of marketing efforts exist to incentivize shopping behavior or provide data-oriented feedback to a merchant. Coupons, for example, may be issued by a manufacturer or merchant and may entitle a consumer to a financial discount or rebate when purchasing a product. In return, the manufacturer may collect data regarding distribution channels or price sensitivity of various groups of buyers.

Another type of marketing effort to incentivize shopping behavior may be loyalty programs. Loyalty programs are programs that reward loyal buying behavior. Generally a merchant may issue a customer a loyalty card or an identifier to help the merchant recognize a loyal buyer and may record a purchase history of the buyer. Loyalty cards sometimes have a barcode or magnetic stripe that can be electronically scanned. Other types of technology used for loyalty identification include radio-frequency identification (RFID) modules, unique database number identifiers or key-ring cards. Loyalty programs may also provide reward points to loyal customers or enable customer to enter drawings for prizes.

### BRIEF DESCRIPTION OF THE DRAWINGS

FIG. 1 is a diagram illustrating an example of a mobile computing device receiving an audio signal from an identifier distribution device.

FIG. 2 is a schematic overview of an example of a mobile computing device confirming a location.

FIG. 3 is a block diagram illustrating an example of a system for confirming location of a computing device.

FIG. 4 is a block diagram illustrating an example of an identifier distribution device transmitting an audio signal to a mobile computing device.

FIG. 5 is flowchart illustrating an example of a method for confirming that a device is at a geographic location.

FIG. 6 is block diagram illustrating an example of a computing device for confirming that a device is at a geographic location.

### DETAILED DESCRIPTION

Technology is described for confirming that a device is at a geographic location. This technology, for example, may be used as a means to incentivize shopping behavior or to provide rewards and prizes to a customer. For instance, a rewards program may use the technology to record shopping visits and/or purchases.

An identifier may be associated with a geographic location. For instance, a device identifier may be stored and linked with a retail store location in a database. An audio signal containing the identifier may be generated by the device. A mobile computing device such as a cellular phone or smart phone may receive the audio signal in the retail store. The smart phone may then validate the identifier to verify that the smart phone is in the store. In validating the identifier, a database may be queried for data to provide data-oriented feedback, for example.

A device that generates and transmits an audio signal containing an identifier may have several advantages over previous technology. For example, the device may be more durable and be able to withstand the types of abuses that occur in a retail environment. Moreover, the device may be able to better withstand the elements in an outdoor setting. Additionally the device may be more cost-effective to produce and may be less likely to be stolen since the device's inherent value may be minimal.

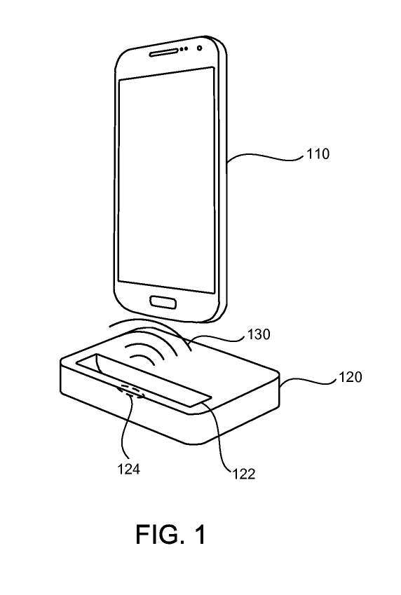

To more readily describe the technology, reference is now made to the figures. In particular, FIG. 1 is a diagram illustrating an example of a mobile computing device 110 receiving an audio signal 130 from an identifier distribution device 120. The mobile computing device 110, in one example, may be a smart phone and may have a microphone located towards the bottom of the mobile computing device 110.

The identifier distribution device 120 may include a cradle area 122 in which the mobile computing device 110 may be inserted. By inserting the mobile computing device 110 into the cradle area 122, the mobile computing device 110 may be able to more readily receive the audio signal 130. In particular, the identifier distribution device 120 may include a speaker 124 towards the bottom on the cradle 122 that may be used to emanate the audio signal 130. In this way, when the mobile computing device 110 is placed in the cradle 122 of the identifier distribution device, the speaker 124 may be in close proximity to a microphone on the mobile computing device 110. Thus, transmission of the audio signal 130 from the identifier distribution device 120 to the mobile computing device 110 may be more reliable.

The identifier distribution device 120 may have a hardware identifier, a processor and a memory. Moreover the identifier distribution device 120 may be placed in a geographic location. For example, the identifier distribution device 120 may be placed at a retail location. Thus in use, the hardware identifier may be associated with a geographic location of the identifier distribution device 120 having a processor and memory.

The hardware identifier may be encoded in the audio signal 130 by the identifier distribution device 120 and transmitted from the identifier distribution device 120 using the speaker 124. The mobile computing device 110 may then receive the audio signal 130 using a microphone. The hardware identifier may be a media access control (MAC) address.

The audio signal 130 may include other information encoded information. Some of this information may help with the transmission and reception of the audio signal 130. For example, the audio signal 130 may include a cyclic redundancy check (CRC) to detect errors in the transmission of the audio signal 130. A time stamp generated by the identifier distribution device 120 may be included in the audio signal 130 to indicate a time when the audio signal 130 was transmitted. Checking the time when the audio signal was sent can avoid fraudulent audio signal transmissions.

The mobile computing device 110 may verify the hardware identifier encoded in the audio signal 130. Moreover, the mobile computing device 110 may also check whether the hardware identifier is a correct length and corresponds to a known hardware identifier. The mobile computing device 110, for example, may query an application database on the mobile computing device 110 or may query a server to verify the hardware identifier and determine the geographic location associated with the hardware identifier.

In verifying the hardware identifier, the mobile computing device 110 may execute an application on the mobile computing device 110. In this way, the geographic location of the mobile computing device 110 may be determined using the hardware identifier, since the mobile computing device 110 may have received the hardware identifier from the identifier distribution device 120 which may be associated with the geographic location.

The audio signal 130 may also include other information. For example, a transaction count value can be included in the audio signal 130 to represent a number of registration events at the identifier distribution device 120. Furthermore, the audio signal may be encrypted using a public key in order to provide increased security.

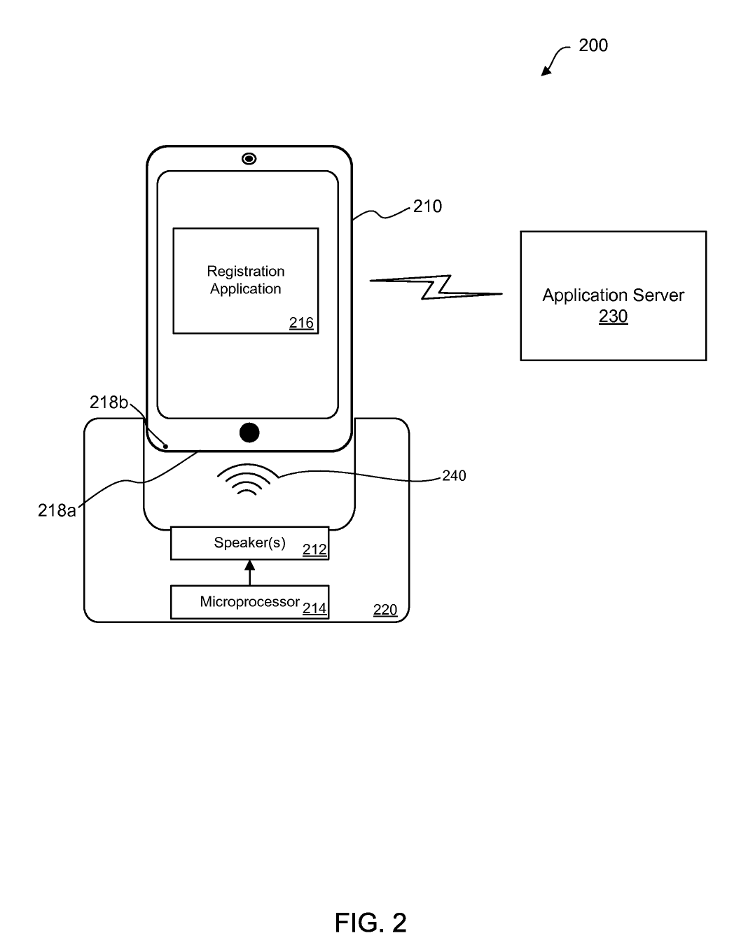

FIG. 2 is a schematic overview of an example of a mobile computing device 210 confirming a location. The mobile computing device 210 receives the audio signal 240 from an identifier distribution device 220 containing an identifier associated with a geographic location. The identifier is then validated via the mobile computing device 210 to verify that the mobile computing device 210 is at the geographic location. For example, the identifier distribution device 220 may be located in a retail store and the mobile computing device 210 may validate that the mobile computing device 210 is at the retail store after receiving the audio signal 130 by communicating with an application server 230. More particularly, a registration application 216 may be used to receive the audio signal 130 and communicate with the application server 230.

The application server 230 may be an Internet-connected server that the mobile computing device 210 may be able to reach over an Internet-connected cellular network. Examples of cellular networks that connect to the Internet include 4G (fourth generation) technologies such as LTE (long term evolution), 3G technologies such as UMTS (universal mobile telecommunications system), HSPA (high-speed packet access) and 2G technologies such as EDGE (enhanced data rates for GSM (global system for mobile communications) evolution), as a few examples.

A microprocessor 214 may be used to generate the audio signal 130 on the mobile computing device 210 and output the audio signal 240 using a speaker 212. The mobile computing device 210 may be inserted into a cradle area such that a bottom side 218a may be inside an enclosing space of the identifier distribution device 220. In this way, a microphone 218b may be in close proximity with the speaker 212 such that transmission of the audio signal 130 may be easily made without undue interference.

The identifier of the identifier distribution device 220 may be stored in a memory, such as a read-only memory (ROM) or flash memory, for example. As previously discussed, the identifier may be transmitted using the audio signal 240 by encoding the identifier into the audio signal 130. In another example configuration, the audio signal may be a square wave signal output to the speaker to be used as an audio signal. In this way, the identifier distribution device 220 may be constructed without the expense of a digital-to-analog converter (DAC). Moreover, since communication with the application server 230 is made by a mobile computing device 210, the identifier distribution device may not necessarily need to be communicatively connected to the application server 230. This may further reduce costs and may simplify mass production of the identifier distribution device 220.

Operational use of the identifier distribution device 220 may be simplified since the identifier distribution device 220 may only require power. In a minimalistic design of the identifier distribution device 220, the identifier distribution device 220 may incorporate a small solar array and battery capacity. In this way, the identifier distribution device 220 may be self-sustaining and may be placed in an outdoor environment.

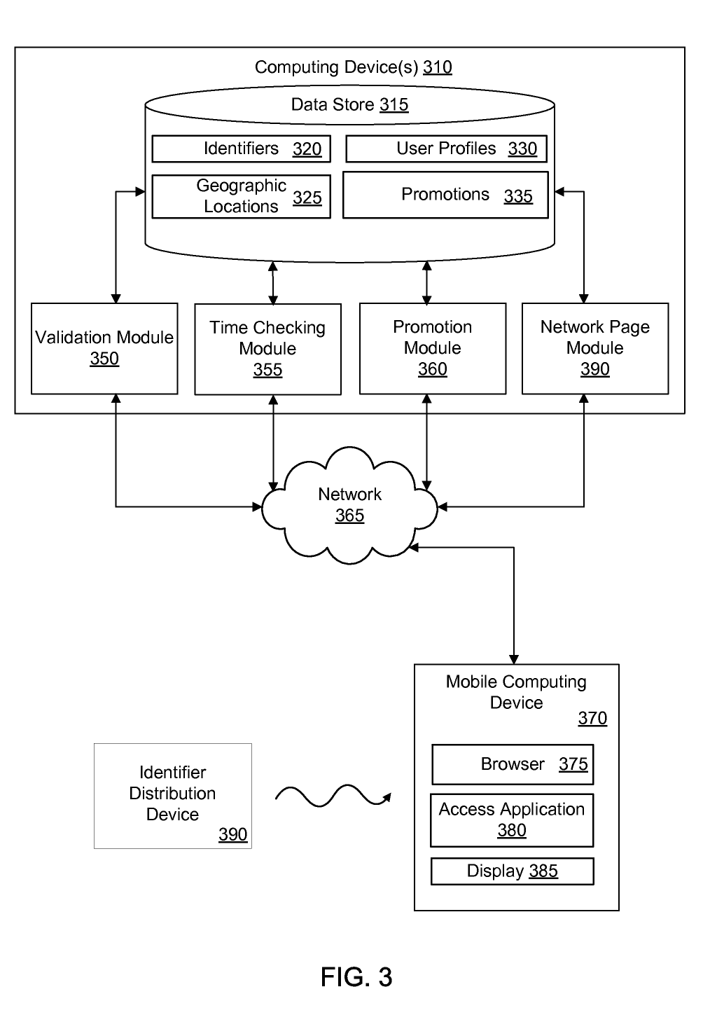

FIG. 3 is a block diagram illustrating an example of a system for confirming location of a computing device. A computing device 310 may be a server used for the application server 230 as discussed with reference to FIG. 2 and may be communicatively connected to a network 365. As has discussed previously, the identifier distribution device 390 may transmit an audio signal to a mobile computing device 370 for reception by the mobile computing device 370.

The mobile computing device 370 may be a cellular phone and may include a browser 375 and a display 385. The mobile computing device 370 may be connected to the computing device 310 over the network 365. The network 365 may, for example, be the Internet. Moreover, the mobile computing device 370 may also include an access application 380 to streamline interaction with the computing device 310 and/or the identifier distribution device 390. In particular, the access application 380 may validate the hardware identifier and identify a geographic location associated with the hardware identifier.

As was discussed previously, the hardware identifier may be encoded on an audio signal transmitted from the identifier distribution device 390 to the mobile computing device 370. Thus, the identifier distribution device 390 may include a speaker configured to output the hardware identifier using an audio signal and the mobile computing device 370 may have a microphone communicatively coupled to the mobile computing device configured to receive the audio signal containing the hardware identifier.

The identifier distribution device 390 may include a channel with an acoustically transparent wall configured to enable the audio signals to pass through the acoustically transparent wall from the speaker. In this way, the speaker may be enclosed from the elements while still being capable of transmitting the audio signal. This example may be useful, for instance, in outdoor environments where the identifier distribution device 390 may have to withstand precipitation, extreme temperatures and other weather-related environmental conditions.

The identifier distribution device 390 may also include a chamber formed in the identifier distribution device 390 to provide acoustic isolation between the identifier distribution device 390 and the mobile computing device. This example may be useful, for instance, where there is a high level of environmental noise. Noisy construction in proximity to a retail store employing the identifier distribution device 390, for example, may not necessarily impair use of the identifier distribution device 390.

A data store 315 may store information for the computing device 310. The term “data store” may refer to any device or combination of devices capable of storing, accessing, organizing, and/or retrieving data, which may include any combination and number of data servers, relational databases, object oriented databases, simple web storage systems, cloud storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media.

The data store 315, for example may include an identifiers data store 320 which may contain hardware identifiers for various identifier distribution devices including the identifier distribution device 390. Likewise a geographic locations data store 325 may associate the identifiers in the identifiers data store 320 with physical locations. The geographic locations data store 325, therefore, may include information such as global positioning coordinates, an address, or a store identifier.

The user profiles data store 330 may include information related to various users. For example a user may be identified by a mobile computing device or a username and password. The promotions data store 330, may include various promotions that users in the user profiles data store 330 may be eligible for.

Various modules may also be included in the computing device 310. For example, a validation module 350 may be used to validate the identifier by comparing an identifier with the information in the identifiers data store 320. The validation module 350 may also perform a CRC. A time checking module 355 may be used to ensure that a signal being processed is validly ordered. In this way, a recorded audio signal may not simply be reused if a time stamp is encoded within the audio signal.

A promotions module 360 may provide promotional information based on what a user is eligible for and may further provide capabilities to redeem a promotion. For example, the promotions module 360 may provide how many points a user may get for visiting an identifier distribution device. The network page module may provide presentation layer interaction with the mobile computing device 370. In this way, the network page module 390 may include a hypertext transfer protocol (HTTP) server to provide content to the browser 375 and/or the content access application 380. Additionally the mobile computing device 370 may connect to the computing device 310 over a transport layer security (TLS) or a secure sockets layer (SSL) connection to provide security.

While the mobile computing device 370 has been explained in reference to a cellular phone, the mobile computing device 370 may also be a device such as, but not limited to, a laptop, a tablet, a mobile device, a hand held messaging device, a personal data assistant, an electronic book reader, or any device capable of interacting with the identifier distribution device 390 and the computing device 310.

Certain processing modules may be discussed in connection with this technology. In one example configuration, a module may be considered a service with one or more processes executing on a server or other computer hardware. Such services may be centrally hosted functionality or a service application that may receive requests and provide output to other services or consumer devices. For example, modules providing services may be considered on-demand computing that is hosted in a server, cloud, grid, or cluster computing system. An application program interface (API) may be provided for each module to enable a second module to send requests to and receive output from the first module. Such APIs may also allow third parties to interface with the module and make requests and receive output from the modules. Third parties may either access the modules using authentication credentials that provide on-going access to the module or the third party access may be based on a per transaction access where the third party pays for specific transactions that are provided and consumed.

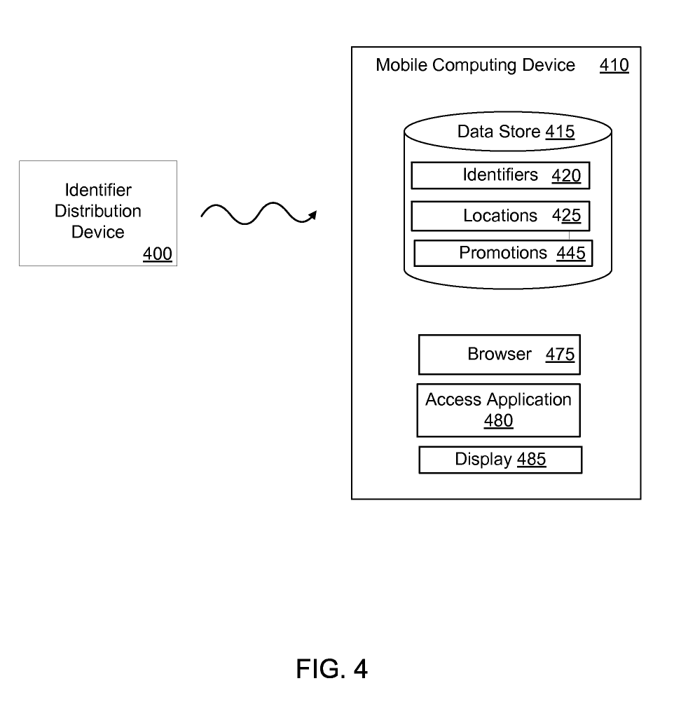

FIG. 4 is a block diagram illustrating an example of an identifier distribution device 400 transmitting an audio signal to a mobile computing device 410. In contrast to FIG. 3, the mobile computing device 410 may contain some of the functionality contained in the computing device 310. For example, a data store 415 may include an identifiers data store 420, a locations data store 425 and a promotions data store 445 as were discussed with reference to FIG. 3. Likewise, the mobile computing device 410 may also retain functionality such as a browser 475, an access application 480 and a display 485. In this way, the mobile computing device 410 in some cases may contain the functionality necessary to operate without a centralized application server.

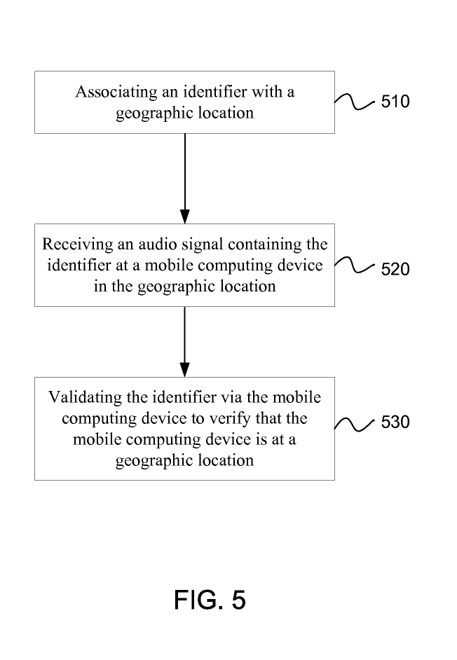

FIG. 5 is flowchart illustrating an example of a method for confirming that a device is at a geographic location. The method include associating an identifier with a geographic location, as shown in method element 510, and receiving an audio signal containing the identifier at a mobile computing device in the geographic location, as shown in the method element 520. The method may also include validating the identifier via the mobile computing device to verify that the mobile computing device is at a geographic location, as shown in the method element 530.

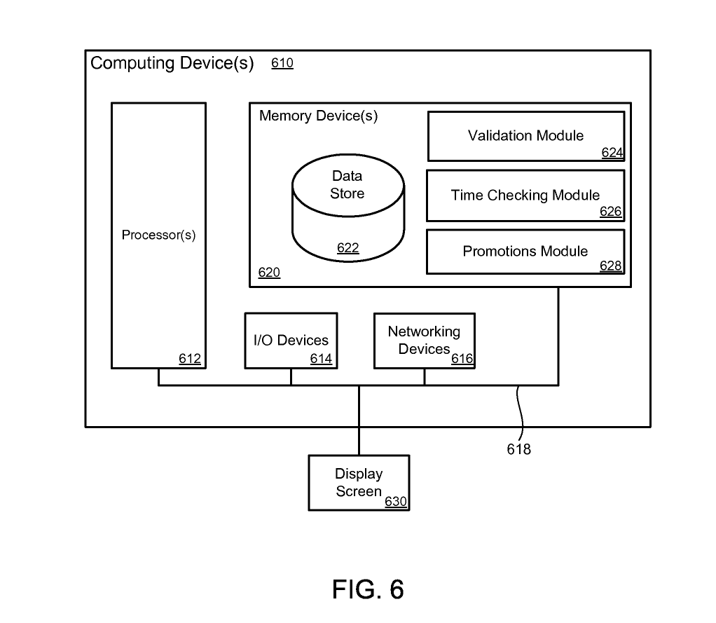

FIG. 6 is block diagram illustrating an example of a computing device for confirming that a device is at a geographic location. More particularly, FIG. 6 illustrates a computing device 610 on which modules of this technology may execute. A computing device 610 is illustrated on which a high level example of the technology may be executed. The computing device 610 may include one or more processors 612 that are in communication with memory devices 620. The computing device may include a local communication interface 618 for the components in the computing device. For example, the local communication interface may be a local data bus and/or any related address or control busses as may be desired.

The memory device 620 may contain modules that are executable by the processor(s) 612 and data for the modules. Located in the memory device 620 are modules executable by the processor. For example, a validation module 624, a time checking module 626, a promotions module 628 and other modules may be located in the memory device 620. The modules may execute the functions described earlier. A data store 622 may also be located in the memory device 620 for storing data related to the modules and other applications along with an operating system that is executable by the processor(s) 612.

Other applications may also be stored in the memory device 620 and may be executable by the processor(s) 612. Components or modules discussed in this description that may be implemented in the form of software using high programming level languages that are compiled, interpreted or executed using a hybrid of the methods.

The computing device may also have access to I/O (input/output) devices 614 that are usable by the computing devices. An example of an I/O device is a display screen 630 that is available to display output from the computing devices. Other known I/O device may be used with the computing device as desired. Networking devices 616 and similar communication devices may be included in the computing device. The networking devices 616 may be wired or wireless networking devices that connect to the internet, a LAN, WAN, or other computing network.

The components or modules that are shown as being stored in the memory device 620 may be executed by the processor 612. The term “executable” may mean a program file that is in a form that may be executed by a processor 612. For example, a program in a higher level language may be compiled into machine code in a format that may be loaded into a random access portion of the memory device 620 and executed by the processor 612, or source code may be loaded by another executable program and interpreted to generate instructions in a random access portion of the memory to be executed by a processor. The executable program may be stored in any portion or component of the memory device 620. For example, the memory device 620 may be random access memory (RAM), read only memory (ROM), flash memory, a solid state drive, memory card, a hard drive, optical disk, floppy disk, magnetic tape, or any other memory components.

The processor 612 may represent multiple processors and the memory 620 may represent multiple memory units that operate in parallel to the processing circuits. This may provide parallel processing channels for the processes and data in the system. The local interface 618 may be used as a network to facilitate communication between any of the multiple processors and multiple memories. The local interface 618 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A computer-implemented method, comprising:
under control of one or more computer systems configured with executable instructions:
associating an identifier with a geographic location;
receiving an audio signal containing the identifier at a mobile computing device in the geographic location; and
validating the identifier via the mobile computing device to verify that the mobile computing device is at the geographic location.

2. The method as in claim 1, further comprising transmitting the identifier from an identifier distribution device using the audio signal.

3. The method as in claim 1, further comprising storing the identifier in an identifier distribution device in a memory.

4. The method as in claim 1, further comprising transmitting the identifier using a speaker of an identifier distribution device and receiving the audio signal using a microphone of the mobile computing device.

5. The method as in claim 1, further comprising transmitting a time value in the audio signal.

6. The method as in claim 1, further comprising transmitting a transaction count value representing a number of transactions credited to a user of the mobile computing device.

7. A method for confirming a location of a mobile computing device, comprising:
under control of one or more computer systems configured with executable instructions:
associating a hardware identifier with a geographic location of an identifier distribution device having a processor and memory;
encoding the hardware identifier in an audio signal using the identifier distribution device;
transmitting an audio signal from the identifier distribution device using a speaker;
receiving the audio signal at the mobile computing device using a microphone;
verifying the hardware identifier via the mobile computing device; and
determining the geographic location of the mobile computing device using the hardware identifier.

8. The method as in claim 7, further comprising encoding a time stamp generated by the identifier distribution device into the audio signal.

9. The method as in claim 7, further comprising using the hardware identifier that is a MAC address (media access code address).

10. The method as in claim 7, further comprising verifying the hardware identifier via an application executing on the mobile computing device.

11. The method as in claim 7, further comprising verifying the hardware identifier via the mobile computing device that is a cellular phone.

12. The method as in claim 7, further comprising encoding a transaction count value into the audio signal representing a number of registration events at the identifier distribution device.

13. The method as in claim 7, further comprising encrypting the audio signal using a public key.

14. The method as in claim 7, further comprising storing the association between the hardware identifier and the geographic location in a data store on a central server.

15. The method as in claim 7, further comprising encoding the hardware identifier into the audio signal using a microprocessor in the identifier distribution device.

16. A system for confirming a location of a computing device comprising:
an identifier distribution device having a hardware identifier, a microprocessor and memory;
a speaker in the identifier distribution device configured to output the hardware identifier using an audio signal;
a mobile computing device;
a microphone in communication with the mobile computing device, the microphone being configured to receive the audio signal containing the hardware identifier; and
an application on the mobile computing device, the application being configured to validate the hardware identifier and identify a geographic location associated with the hardware identifier.

17. The system as in claim 16, further comprising a channel in the identifier distribution device with an acoustically transparent wall configured to enable the audio signals to pass through the acoustically transparent wall from the speaker.

18. The system as in claim 16, wherein the mobile computing device is a cell phone.

19. The system as in claim 16, wherein the hardware identifier is a MAC address (media access code address).

20. The system as in claim 16, wherein the identifier distribution device has a chamber formed in the identifier distribution device to provide acoustic isolation between the identifier distribution device and mobile computing device.
